(19) United States
(12) Patent Application Publication
(10) Pub. No.: US 2019/0094072 A1
(43) Pub. Date: Mar. 28, 2019

(54) ATOMIC EMISSION SPECTROMETER BASED ON LASER-INDUCED PLASMA (LIP), SEMICONDUCTOR MANUFACTURING FACILITY INCLUDING THE ATOMIC EMISSION SPECTROMETER, AND METHOD OF MANUFACTURING SEMICONDUCTOR DEVICE USING THE ATOMIC EMISSION SPECTROMETER

(71) Applicant: SAMSUNG ELECTRONICS CO., LTD., Suwon-si (KR)

(72) Inventors: Sang-gil PARK, Hwaseong-si (KR); Byeong-hwan JEON, Yongin-si (KR); Tae-heung AHN, Seoul (KR)

(73) Assignee: SAMSUNG ELECTRONICS CO., LTD., Suwon-si (KR)

(21) Appl. No.: 15/867,981

(22) Filed: Jan. 11, 2018

(30) Foreign Application Priority Data
Sep. 22, 2017 (KR) 10-2017-0122871

(51) Int. Cl. G01J 3/18; G01J 3/443; G01J 3/36

(52) U.S. Cl. CPC G01J 3/18; G01J 3/36; G01J 3/443

(57) ABSTRACT

Provided are an atomic emission spectrometer (AES), which may be downscaled with high detection intensity, a semiconductor manufacturing facility including the AES, and a method of manufacturing a semiconductor device using the AES. The AES includes: at least one laser generator configured to generate laser beams; a chamber including an elliptical or spherical mirror disposed inside the chamber and configured to reflect the laser beams transmitted into the chamber so that the laser beams are condensed and irradiated on an analyte contained in the chamber to generate plasma and emit plasma light; a supplier connected to the chamber to supply the analyte into the chamber; and a spectrometer configured to receive and analyze the plasma light, and obtain data regarding the plasma light to detect elements in the analyte.

### CROSS-REFERENCE TO THE RELATED APPLICATION

This application claims priority from Korean Patent Application No. 10-2017-0122871, filed on Sep. 22, 2017, in the Korean Intellectual Property Office, the disclosure of which is incorporated herein in its entirety by reference.

### BACKGROUND

Apparatuses and methods consistent with the inventive concept relate to a semiconductor device manufacturing device and a method of manufacturing a semiconductor device, and more particularly, to an atomic emission spectrometer (AES) configured to inspect and analyze atomic emission of an analyte, a semiconductor manufacturing facility including the AES, and a method of manufacturing a semiconductor device using the AES.

A spectrometer may be a device configured to measure spectrum of light emitted by or absorbed into a material. The spectrometer may resolve electromagnetic waves (EMWs) according to a difference in wavelength, and measure an intensity distribution of the EMW to obtain information regarding arrangements of electrons and atomic nuclei in an analyte and motion of the analyte. In particular, the spectrometer may measure and analyze an emission spectrum to detect specific elements in the analyte. Spectrometers may include, for example, an interference spectrometer, a grating spectrometer, and a prism spectrometer. The interference spectrometer may be a device configured to cause many rays of light to interfere with one another. A typical example of the interference spectrometer may be a Fabry-Perot interferometer. The grating spectrometer, which is a spectrometer using diffraction gratings, may be suitable for infrared (IR) or ultraviolet (UV) spectroscopy because the grating spectrometer is highly capable of separating light having close wavelengths, and does not cause absorption of light into glass. The prism spectrometer, which has been widely used from the past, may include a collimator, a prism, and a camera.

### SUMMARY

The exemplary embodiments of the inventive concept provide an atomic emission spectrometer (AES), which may be downscaled with high detection intensity, a semiconductor manufacturing facility including the AES, and a method of manufacturing a semiconductor device using the AES.

According to an aspect of an exemplary embodiment, there is provided a laser-induced plasma (LIP)-based AES which may include: at least one laser generator configured to generate laser beams; a chamber including an elliptical or spherical mirror disposed inside the chamber and configured to reflect the laser beams transmitted into the chamber so that the laser beams are condensed and irradiated on an analyte contained in the chamber to generate plasma and emit plasma light; a supplier connected to the chamber to supply the analyte into the chamber; and a spectrometer configured to receive and analyze the plasma light, and obtain data regarding the plasma light to detect elements in the analyte.

According to an aspect of an exemplary embodiment, there is provided an LIP-based AES which may include: a chamber configured to receive an analyte; at least one laser generator configured to generate laser beams; an optics comprising a focal optics through which the laser beams are transmitted onto a condensing point formed inside the chamber to generate plasma; a supplier connected to the chamber to supply the analyte into the chamber; and a spectrometer configured to receive and analyze plasma light from the plasma, and obtain data regarding the plasma light to detect elements in the analyte.

According to an aspect of an exemplary embodiment, there is provided a semiconductor manufacturing system which may include: a chemical storage configured to store a chemical used for at least one of processes including cleaning, lithography, etching, oxidation, diffusion and deposition, and polishing; at least one chamber configured to receive the chemical which is applied to a semiconductor for performing the at least one process; a chemical supplier configured to supply the chemical into the at least one chamber for the at least one process; and the AES configured to receive the chemical comprising the analyte and analyse the analyte.

According to an aspect of an exemplary embodiment, there is provided a method of manufacturing a semiconductor device. The method may include: storing a chemical used for at least one of processes comprising cleaning, lithography, etching, oxidation, diffusion, deposition, and polishing; supplying analyte comprising a part of the chemical into an AES for analyzing the analyte; and supplying the chemical into at least one chamber for performing the at least one process according to a result of the analyzing the analyte. Here, the analyzing the analyte by the AES may include: supplying the analyte into a chamber of the AES; applying laser beams into the chamber so that the laser beams are reflected by a mirror disposed in the chamber to be condensed and irradiated on the analyte to generate plasma and emit plasma light therefrom; and controlling the plasma light to emit out to a spectrometer which analyzes the plasma light.

### BRIEF DESCRIPTION OF THE DRAWINGS

Embodiments of the inventive concept will be more clearly understood from the following detailed description taken in conjunction with the accompanying drawings in which:

FIG. 1 is a schematic block diagram of a structure of a laser-induced plasma (LIP)-based atomic emission spectrometer (AES) according to an exemplary embodiment;

FIG. 2A is a detailed block diagram of a structure of an input optics in the LIP-based AES of FIG. 1, according to an exemplary embodiment;

FIG. 2B is a perspective view of a chamber according to an exemplary embodiment;

FIG. 2C is a detailed block diagram of a structure of spectrometer according to an exemplary embodiment;

FIGS. 3 to 5 are schematic block diagrams of structures of LIP-based AESs according to exemplary embodiments;

FIG. 6A is a schematic block diagram of a structure of an LIP-based AES according to an exemplary embodiment;

FIG. 6B is a detailed perspective view of a condensing mirror according to an exemplary embodiment;

FIG. 7A is a schematic block diagram of a structure of an LIP-based AES according to an exemplary embodiment;

FIG. 7B is a detailed block diagram of a portion of a droplet forming device according to an exemplary embodiment;

FIG. 8 is a schematic block diagram of a structure of an LIP-based AES according to an exemplary embodiment;

FIG. 9 is a schematic block diagram of a structure of a semiconductor manufacturing facility including an LIP-based AES according to an exemplary embodiment;

FIG. 10 is a flowchart of a process of analyzing an analyte by using an LIP-based AES according to an exemplary embodiment; and

FIG. 11 is a flowchart of a method of manufacturing a semiconductor device by using an LIP-based AES according to an exemplary embodiment.

### DETAILED DESCRIPTION OF THE EXEMPLARY EMBODIMENTS

Various exemplary embodiments of the inventive concept will be described more fully hereinafter with reference to the accompanying drawings. The inventive concept may, however, be embodied in many different forms and should not be construed as limited to the example embodiments set forth herein. Rather, these embodiments are provided so that this description will be thorough and complete, and will fully convey the scope of the inventive concept to those skilled in the art. In the drawings, the sizes and relative sizes of layers and regions may be exaggerated for clarity.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “over,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when an exemplary embodiment can be implemented differently, functions or operations described in a particular block may occur in a different way from a flow described in the flowchart. For example, two consecutive blocks may be performed simultaneously, or the blocks may be performed in reverse according to related functions or operations.

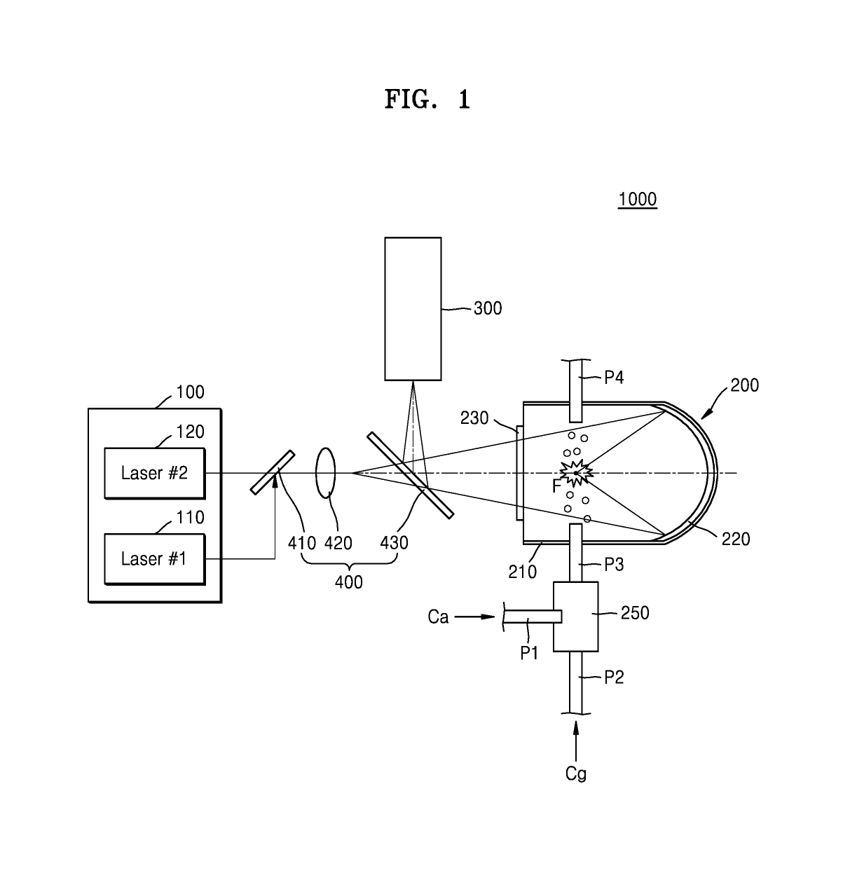

FIG. 1 is a schematic block diagram of a structure of a laser-induced plasma (LIP)-based atomic emission spectrometer 1000 according to an exemplary embodiment.

Referring to FIG. 1, the LIP-based atomic emission spectrometer 1000 of the present embodiment may include a laser generation unit 100, a chamber 200, a spectrometer 300, and an input optics 400. As can be seen from the term ‘LIP’, the LIP-based atomic emission spectrometer 1000 of the present embodiment may generate plasma by using laser beams, receive plasma light from plasma, obtain and analyze an emission spectrum, and detect ultratrace elements. Plasma may refer to an aggregate of particles, which are separated into electrons, positively charged ions, and neutral radicals at ultrahigh temperatures. In a plasma state, the electrons may be relaxed from an excited state to a ground state to emit light (i.e., plasma light). Hereinafter, an ‘LIP-based atomic emission spectrometer’ will be simply referred to as an ‘atomic emission spectrometer’ for brevity. Meanwhile, the atomic emission spectrometer 1000 may also be referred to as an AES or an optical emission spectrometer (OES).

The laser generation unit 100 may include a first laser generator 110 and a second laser generator 120. In some embodiments, the laser generation unit 100 may include only the first laser generator 110.

The first laser generator 110 may be a pulse laser generator. Thus, the first laser generator 110 may generate pulse laser beams, for example, visible pulse laser beams. Naturally, the pulse laser beams generated by the first laser generator 110 are not limited to visible pulse laser beams. For example, the pulse laser beams generated by the first laser generator 110 may have various wavelengths, such as an infrared ray wavelength and an ultraviolet ray wavelength.

Pulse laser beams from the first laser generator 110 may have a very high peak power. For example, the pulse laser beams from the first laser generator 110 may be incident into the chamber 200 and have such a peak power as to be capable of igniting plasma. The pulse laser beams from the first laser generator 110 may be continuously incident to the chamber 200 while plasma is maintained from the moment in which the plasma is ignited. In some embodiments, the pulse laser beams from the first laser generator 110 may be used only for plasma ignition, and thus incident to the chamber 200 only during a short time duration for which plasma is ignited.

The second laser generator 120 may be a continuous wave (CW) laser generator. Thus, the second laser generator 120 may generate CW laser beams, for example, infrared ray (IR) CW laser beams. Naturally, the CW laser beams generated by the second laser generator 120 are not limited to IR CW laser beams.

The CW laser beams from the second laser generator 120 may be incident to the chamber 200 and maintain the inside of the chamber 200 at high temperatures before plasma ignition. Also, after the plasma ignition, the CW laser beams from the second laser generator 120 may be used to maintain plasma or increase the intensity of plasma. Thus, the incidence of the CW laser beams from the second laser generator 120 to the chamber 200 may begin before plasma ignition and continue while plasma is maintained. In some embodiments, the CW laser beams from the second laser generator 120 may be incident to the chamber 200 after plasma ignition.

The chamber 200 may be a container in which a gaseous or liquid analyte is contained and plasma is generated. For example, laser beams may be irradiated to an analyte in the chamber 200 to generate plasma, and plasma light from the plasma may be emitted out of the chamber 200.

The chamber 200 may include a body 210, an elliptical mirror 220, and a window 230. The body 210 may define a reaction space in which plasma is generated, and isolate the reaction space from the outside. The body 210 may typically include a metal material and be maintained in a ground state to block noise from the outside during a plasma process. An insulating liner may be located inside the body 210. The insulating liner may protect the body 210 and prevent occurrence of arcing in the chamber 200. The insulating liner may include ceramic or quartz.

The elliptical mirror 220 may be located at an inner side surface of the body 210 and include a material capable of reflecting laser beams and plasma light. For example, an inner portion of the elliptical mirror 220 may include a material, such as Pyrex or quartz, and an outer portion of the elliptical mirror 220 may include a metal material. In some embodiments, the elliptical mirror 220 may be optically coated to reflect only light of a required wavelength band.

The elliptical mirror 220 may condense incident light on a focal position, reflect light generated at the focal position, and output the reflected light out of the chamber 200. For reference, the elliptical mirror 220 may have two foci and conform to the law of reflection by which light from any one of the two foci is reflected by the elliptical mirror 220 and travels toward the other one of the two foci. Thus, laser beams may be reflected by the elliptical mirror 220 and condensed on a condensing point in the chamber 200, for example, a focus F of the elliptical mirror 220. Also, plasma light from plasma generated at a position of the focus F of the elliptical mirror 220 may be reflected by the elliptical mirror 220 and emitted out of the chamber 200. As a result, the elliptical mirror 220 may increase efficiency of input of laser beams to the chamber 200 and efficiency of output of plasma light from the chamber 200.

The window 230 may be a kind of path through which laser beams are incident to the chamber 200 and plasma light is emitted from the chamber 200. The window 230 may have a flat panel shape and include a light-transmissive material, for example, quartz or glass.

As shown in FIG. 1, a nebulizer 250 configured to supply an analyte may be installed in the chamber 200. The nebulizer 250 may vaporize a liquid-state analyte Ca and supply the vaporized liquid-state analyte Ca into the chamber 200. Meanwhile, the nebulizer 250 may supply carrier gas Cg along with the vaporized analyte into the chamber 200. The carrier gas Cg may be, for example, argon (Ar) gas. Argon gas may be an inert gas, which is a kind of gaseous solvent, and contribute toward generating plasma more easily.

More specifically, the liquid-state analyte Ca may be supplied through a first supply line P1 to the nebulizer 250 and vaporized. Also, the carrier gas Cg may be supplied through a second supply line P2 to the nebulizer 250. The nebulizer 250 may supply the vaporized analyte Ca and the carrier gas Cg together through a third supply line P3 to the chamber 200. Meanwhile, a fourth supply line P4 may be located at an opposite side of the third supply line P3, and gases remaining in the chamber 200 may be discharged through a fourth supply line P4.

Although FIG. 1 illustrates an example in which the nebulizer 250 and the first to third supply lines P1, P2, and P3 connected thereto are located in a lower portion of the chamber 200 and the fourth supply line P4 is located in an upper portion of the chamber 200, positions of the nebulizer 250 and the first to fourth supply lines P1, P2, P3, and P4 are not limited thereto. For example, the nebulizer 250 and the first to third supply lines P1, P2, and P3 connected thereto may be located in the upper portion of the chamber 200 or at a side surface of the chamber 200. Also, the fourth supply line P4 may be located at a bottom surface or a side surface of the chamber 200. However, the nebulizer 250 and the first to third supply lines P1, P2, and P3 connected thereto and the fourth supply line P4 may be located at the side surfaces of the chamber 200 to the exclusion of a position in which the elliptical mirror 220 or the window 230 is located.

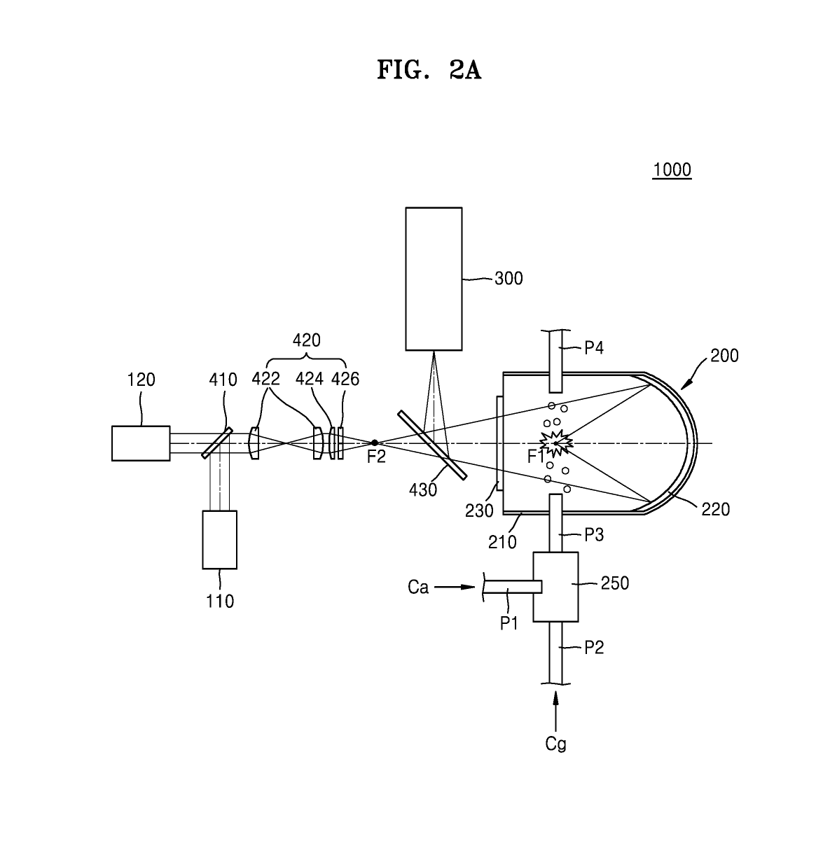

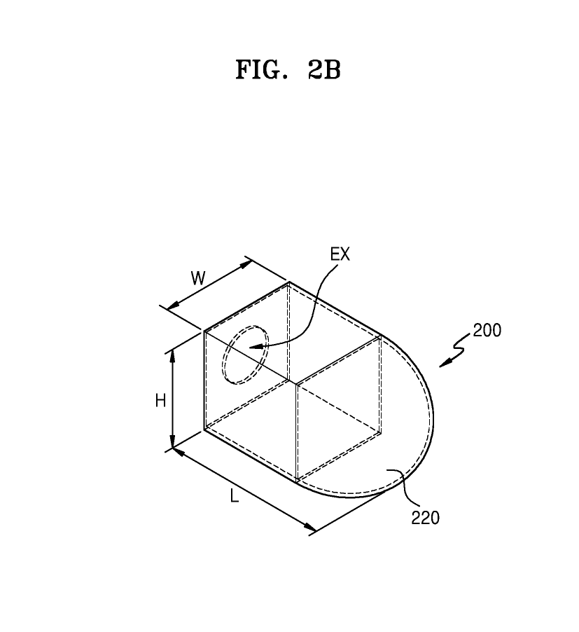

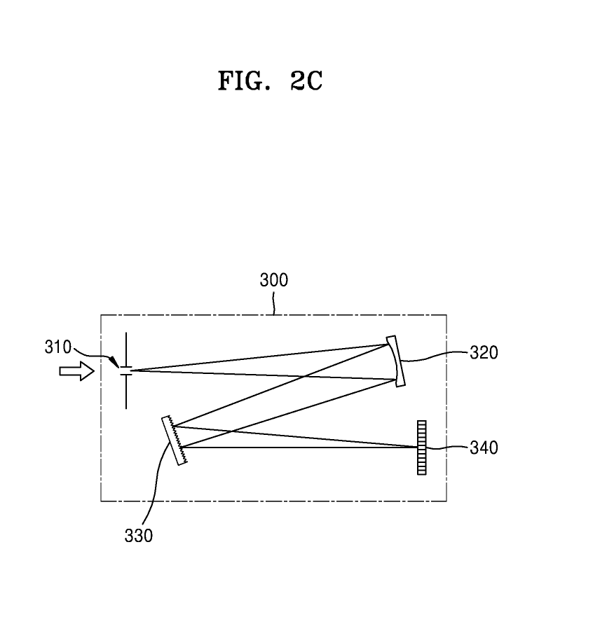

The spectrometer 300 may receive plasma light emitted from the chamber 200, split and resolve the plasma light, and obtain an emission spectrum. Ultratrace elements included in the analyte may be detected based on the emission spectrum obtained by the spectrometer 300. The spectrometer 300 will be described below in further detail with reference to FIG. 2C.

The input optics 400 may serve to allow laser beams from the laser generation unit 100 to be incident to the chamber 200 and allow plasma light from the chamber 200 to be emitted to the spectrometer 300. The input optics 400 may include a first dichroic mirror 410, a focal optics 420, and a second dichroic mirror 430.

The first dichroic mirror 410 may reflect pulse laser beams from the first laser generator 110 toward the chamber 200 and transmit CW laser beams from the second laser generator 120 toward the chamber 200. The first dichroic mirror 410 may be located in a direction in which pulse laser beams are emitted from the first laser generator 110 and CW laser beams are emitted from the second laser generator 120. The first dichroic mirror 410 may be located so that the first laser generator 110 and the second laser generator 120 may maintain a predetermined angle in consideration of reflection and transmission characteristics. For example, the first laser generator 110 and the second laser generator 120 may be located to maintain an angle of about 90° with the first dichroic mirror 410 as a vertex. Also, the first dichroic mirror 410 may be located at an inclination of substantially 45° with respect to each of a direction in which pulse laser beams from the first laser generator 110 travel and a direction in which CW laser beams from the second laser generator 120 travel. In some embodiments, an angle at which the first laser generator 110 and the second laser generator 120 are located may be changed. In this case, an inclination of the first dichroic mirror 410 may be changed.

Meanwhile, materials included in the first dichroic mirror 410 may be changed so that the first dichroic mirror 410 may transmit pulse laser beams from the first laser generator 110 and reflect CW laser beams from the second laser generator 120. In this case, the first laser generator 110 may be located at a left front end of the first dichroic mirror 410, while the second laser generator 120 may be located at a lower end of the first dichroic mirror 410.

The second dichroic mirror 430 may be located at a left front end of the window 230 of the chamber 200. Through the second dichroic mirror 430, both the pulse laser beams from the first laser generator 110 and the CW laser beams from the second laser generator 120 are transmitted toward the chamber 200. Also, the second dichroic mirror 430 may reflect plasma light emitted from the chamber 200 toward the spectrometer 300. More specifically, plasma light may be directly emitted from the chamber 200 through the window 230 and reflected by the second dichroic mirror 430 toward the spectrometer 300. Also, plasma light may be firstly reflected by the elliptical mirror 220, emitted through the window 230, and reflected by the second dichroic mirror 430 toward the spectrometer 300.

Although FIG. 1 illustrates an example in which plasma light emitted from the chamber 200 is reflected by the second dichroic mirror 430 and travels upward, a direction in which plasma light reflected by the second dichroic mirror 430 travels is not limited to an upward direction. For example, an angle at which the second dichroic mirror 430 is located may be controlled so that plasma light may travel downward or sideward. Naturally, the spectrometer 300 may be located in a direction in which plasma light travels. In addition, although not shown, a homogenizer, which is an optical device configured to spatially uniformize light, may be located between the spectrometer 300 and the second dichroic mirror 430.

The focal optics 420 may condense pulse laser beams from the first laser generator 110 and CW laser beams from the second laser generator 120 on one point, for example, a focal position of the elliptical mirror 220. For this purpose, the focal optics 420 may include, for example, a convex lens. The focal optics 420 may further include a lens configured to convert laser beams into ring-shaped beams and a lens configured to compensate for aberration. The focal optics 420 will be described below in further detail with reference to FIG. 2A.

The AES 1000 according to the present embodiment may generate plasma by using laser beams, for example, pulse laser beams, and emit plasma light from the plasma. In this case, the AES 1000 of the present embodiment may condense laser beams and emit plasma light by using the elliptical mirror 220 located in the chamber 200, thereby greatly increasing input efficiency of laser beams and output efficiency of plasma light from the chamber 200. Furthermore, the AES 1000 of the present embodiment may be downscaled based on LIP and increase output efficiency of plasma light based on the above-described condensing structure of the chamber 200. As a result, detection intensity may increase, and analysis reliability may improve.

For reference, typical AESs may use Flame, inductively coupled plasma (ICP), microwave-induced plasma (MIP), direct current plasma (DCP), electric spark/arc, or LIP. However, since plasma generated by Flame, ICP, MIP, or DCP has a large size, an AES having a large footprint may be needed. Also, since electric spark/arc or LIP is capable of generating plasma with a fine size, it may be possible to downscale AESs, but detection intensity may be low and quantitative analysis may be difficult. However, since the AES 1000 of the present embodiment is based on LIP, the AES 1000 may be downscaled. Also, since the elliptical mirror 220 is included in the chamber 200, the intensity of plasma light may increase and thus, detection intensity may increase, thereby solving problems of the typical AESs.

FIG. 2A is a detailed block diagram of a structure of an input optics 400 in the LIP-based AES of FIG. 1, FIG. 2B is a perspective view of a chamber, and FIG. 2C is a detailed block diagram of a structure of spectrometer.

Referring to FIG. 2A, in an AES 1000 of the present embodiment, a focal optics 420 of the input optics 400 may include a pair of axicon lenses 422, a convex lens 424, and a cylindrical lens 426.

The pair of axicon lenses 422 may convert pulse laser beams from the first laser generator 110, which are reflected by the first dichroic mirror 410, and CW laser beams from the second laser generator 120, which are transmitted through the first dichroic mirror 410, into ring-shaped beams. The ring-shaped beams may refer to beams distributed in the form of donuts or circular rings on a section perpendicular to a direction in which light travels. The ring-shaped beams may be formed by using devices (e.g., a spatial light modulator (SLM)) other than the axicon lenses 422. In some embodiments, the pair of axicon lenses 422 may be omitted. In this case, the laser beams may be directly incident to the convex lens 424 and condensed.

The convex lens 424 may serve to condense incident light. For example, when ring-shaped beams are incident to the convex lens 424, the ring-shaped beams may be condensed by the convex lens 424 and reduced to nearly a point at a focal position. Meanwhile, as shown in FIG. 2A, light incident to the convex lens 424 may be condensed on a second focus F2 of an elliptical mirror 220. The condensed light may continuously proceed to the elliptical mirror 220 and be reflected by the elliptical mirror 220 and condensed and irradiated to a first focus F1. As a result, laser beams from the first laser generator 110 and the second laser generator 120 may be converted into ring-shaped beams through the pair of axicon lenses 422 and then condensed again on a condensing point in the chamber 200 (e.g., a focus of the elliptical mirror 220) through the convex lens 424 and the elliptical mirror 220.

While laser beams from the first laser generator 110 and the second laser generator 120 are passing through the second dichroic mirror 430, aberration may occur. To compensate for the aberration, the cylindrical lens 426 may be located at a right side of the convex lens 424. In some embodiments, when the influence of the aberration is immaterial, the cylindrical lens 426 may be omitted.

Referring to FIG. 2B, in the AES 1000 of the present embodiment, a body 210 of the chamber 200 may have a generally hexahedral structure. A rear end portion of the body 210 of the chamber 200 may have an outwardly protruding curved shape corresponding to a shape of the elliptical mirror 220 located in the chamber 200. However, a shape of the body 210 of the chamber 200 is not limited thereto. For example, an outer surface of the body 210 may have a substantially hexahedral structure, and only an inner portion of the body 210 may have a curved shape corresponding to the elliptical mirror 220. Also, the body 210 may have a dome structure roundly surrounding side surfaces of the protruding curved portion. Meanwhile, an exit Ex to which laser beams are incident and from which plasma light is emitted may be formed in a front end surface of the body 210 of the chamber 200. The window (refer to 230 in FIG. 1) may be located at the exit Ex.

In the AES 1000 of the present embodiment, the chamber 200 may be manufactured to be relatively small-sized. For example, each of a length L, width W, and height H of the chamber 200 may range from several mm to several tens of mm. Thus, due to the small size, the chamber 200 may be easily located in a process system or at supply lines configured to supply a chemical to the process system during a semiconductor process. Accordingly, the chemical may be analyzed in real-time or periodically during the semiconductor process. Also, since the chamber 200 adopts a structure including the elliptical mirror 220, input efficiency of laser beams and output efficiency of plasma light may be maximized, thereby increasing detection intensity and improving analysis reliability. For reference, the chemical may contain liquids and gases and be referred to as a liquid chemical in a semiconductor process.

Referring to FIG. 2C, in the AES 1000 of the present embodiment, a spectrometer 300 may include an incidence aperture 310, an imaging mirror 320, a diffraction grating 330, and an array detector 340. In general, optical fibers may be coupled to the spectrometer 300, and plasma light may be incident to the spectrometer 300 through the optical fibers. In the spectrometer 300 having the above-described structure, plasma light may be incident from the optical fibers to the incidence aperture 310. Also, the plasma light spreading from the incidence aperture 310 may be collected on the imaging mirror 320 to form an image. The diffraction grating 330 having a typical plane shape may be located on an optical path, and the array detector 340 may be located at a position where the image is formed. Thus, after the plasma light is incident to the diffraction grating 330, the plasma light may be split and resolved so that an image of the incidence aperture 310 may be formed at another position of the array detector 340 according to a wavelength. Here, the array detector 340 may be embodied by a charge-coupled device (CCD).

The structure of the spectrometer 300 shown in FIG. 2C is only an example, and spectrometers having various other structures may be applied to the AES 1000 of the present embodiment. For example, a spectrometer having another structure may include, instead of an imaging mirror, a collimating mirror configured to collimate light emitted from an incidence aperture and allow the collimated light to travel toward a diffraction grating and a condensing mirror configured to condense light split and resolved by the diffraction grating and allow the condensed light to travel toward an array detector, and an order sorting filter located at a front end of the array detector.

Data (e.g., emission spectrum data) regarding split/resolved light received by the array detector 340 of the spectrometer 300 may be transmitted to an analyzer (not shown) and used to detect elements in an analyte. Although the present embodiment describes an example in which the optical fibers are coupled to the spectrometer 300, in some other embodiments, the optical fibers may not be coupled to the spectrometer 300. In this case, plasma light reflected by the second dichroic mirror 430 may be directly incident to the spectrometer 300 or incident to the spectrometer 300 through a condensing mirror (not shown) at a front end of the spectrometer 300.

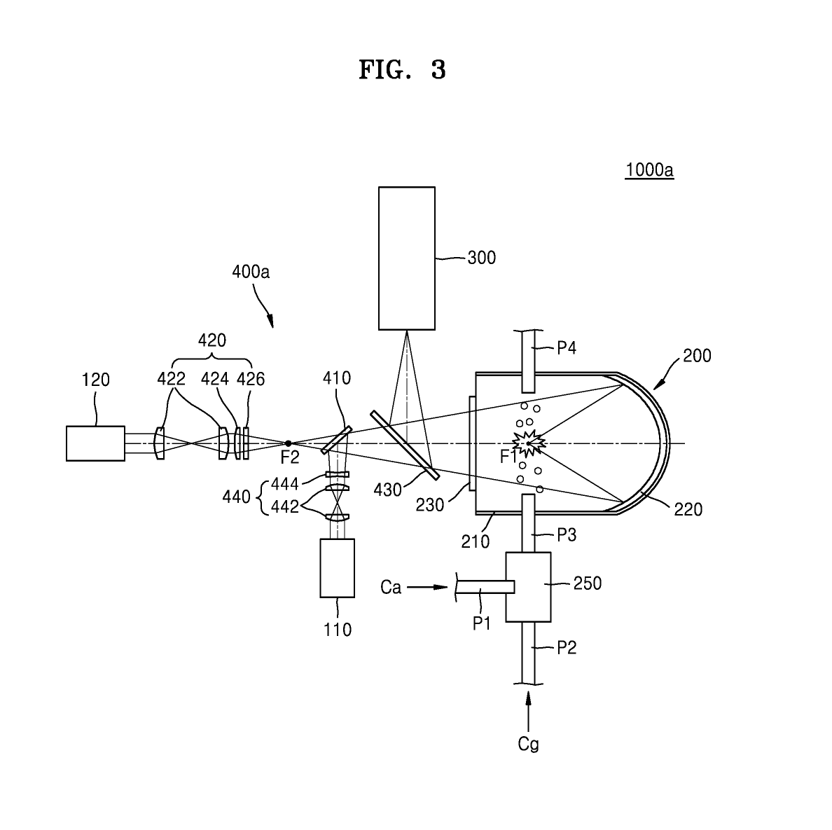

FIGS. 3 to 5 are schematic block diagrams of structures of LIP-based AESs according to exemplary embodiments. The same descriptions as in FIGS. 1 to 2C will be simplified or omitted for brevity.

Referring to FIG. 3, an AES 1000a according to the present embodiment may differ from the AES 1000 of FIG. 1 in terms of a structure of an input optics 400a. Specifically, in the AES 1000a according to the present embodiment, the input optics 400a may include a first dichroic mirror 410, a focal optics 420, a second dichroic mirror 430, and an additional input optics 440.

The first dichroic mirror 410 and the second dichroic mirror 430 of the AES 1000a according to the present embodiment may be the same as those of the AES 1000 of FIG. 1 in that the first dichroic mirror 410 reflects pulse laser beams from the first laser generator 110 and transmits CW laser beams from the second laser generator 120, and the second dichroic mirror 430 transmits both the pulse laser beams from the first laser generator 110 and the CW laser beams from the second laser generator 12, and reflects plasma light. However, as shown in FIG. 3, a focal optics may not be provided between the first dichroic mirror 410 and the second dichroic mirror 430.

The focal optics 420 of the AES 1000a according to the present embodiment may be the same as the focal optics 420 of the AES 1000 of FIG. 1 except that the focal optics 420 of the AES 1000a is located at a left side of the first dichroic mirror 410, and allows CW laser beams from the second laser generator 120 to be condensed on a left portion of the first dichroic mirror 410. Here, a point on which the CW laser beams are condensed by the focal optics 420 may be a second focus F2 of the elliptical mirror 220.

The additional input optics 440 may be an optics configured to allow pulse laser beams from the first laser generator 110 to be incident to the first dichroic mirror 410. The additional input optics 440 may be located at a lower end of the first dichroic mirror 410. The additional input optics 440 may include a pair of axicon lenses 442 and a concave lens 444. The pair of axicon lenses 442 may convert laser beams from the first laser generator 110 into ring-shaped beams. Ring-shaped beams may be formed by using an SLM instead of the pair of axicon lenses 442. In some embodiments, the pair of axicon lenses 442 may be omitted.

The concave lens 444 may serve to expand incident light. For example, when ring-shaped beams are incident to the concave lens 444, an inner radius, outer radius, and width of a ring shape may increase so that the ring shape may entirely expand. In conclusion, the additional input optics 440 may serve to convert the pulse laser beams from the first laser generator 110 into ring-shaped beams, expand the ring-shaped beams, and allow the expanded ring-shaped beams to be incident to the first dichroic mirror 410.

For reference, when pulse laser beams are condensed, plasma may be generated even in the atmosphere, due to the fact that there are media (e.g., oxygen, nitrogen, and water) for igniting plasma in the atmosphere. Accordingly, generation of plasma in the atmosphere may be prevented by adopting the concave lens 444. Also, the concave lens 444 may make light appear to expand from one point. For example, the concave lens 444 and the first dichroic mirror 410 may make laser beams appear to be emitted from the second focus F2 of the elliptical mirror 220. In addition, in the case of the additional input optics 440, a cylindrical lens may be located over the concave lens 444 to compensate for aberration. However, when the influence of aberration is immaterial, the cylindrical lens may be omitted.

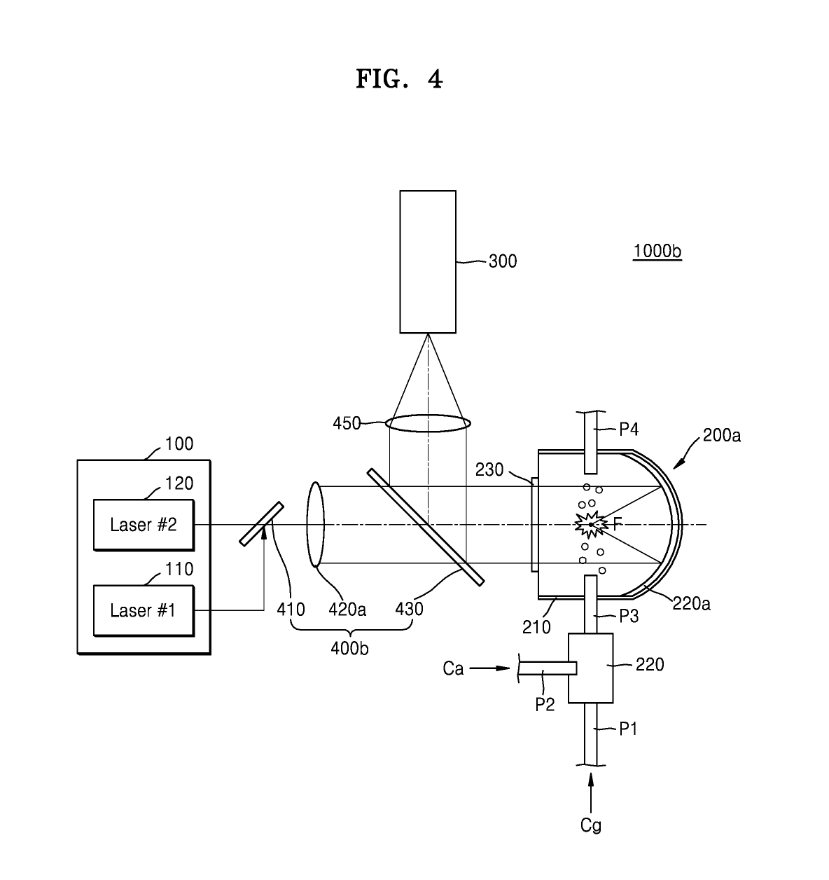

Referring to FIG. 4, an AES 1000b according to the present embodiment may differ from the AES 1000 of FIG. 1 in terms of a structure of a chamber 200a and a structure of an input optics 400b. Specifically, in the AES 1000b of the present embodiment, a spherical mirror 220a may be located in the chamber 200a. For reference, the law of reflection of a spherical mirror will now be described. Incident light parallel to an optical axis may be reflected by the spherical mirror and travel to a focus located on the optical axis. Incident light passing through the focus may be reflected by the spherical mirror and travel parallel to the optical axis. Also, incident light passing through a center of the spherical mirror may be reflected by the spherical mirror and travel to the center of the spherical mirror again.

Due to reflection characteristics of the spherical mirror 220a, pulse laser beams from a first laser generator 110 and CW laser beams from a second laser generator 120 may be incident in the form of collimating beams to the chamber 200a. As described above, light parallel to an optical axis may be reflected by the spherical mirror 220a, condensed on a focus F, and irradiated. Thus, in the AES 1000b of the present embodiment, the input optics 400b may include a beam collimating optics 420a instead of the focal optics 420. The beam collimating optics 420a may be embodied by, for example, omitting the convex lens 424 from the focal optics 420 of the AES 1000 of FIG. 1. When the convex 424 is omitted, ring-shaped beams may be transmitted as collimating beams through the second dichroic mirror 430 and incident to the chamber 200. In some embodiments, a collimating lens may be used instead of the pair of axicon lenses (refer to 422 in FIG. 2A) to obtain typical collimating beams.

Plasma light from the focus F of the spherical mirror 220a may be reflected by the spherical mirror 220a, emitted in the form of collimating light, and reflected by the second dichroic mirror 430 and travel toward the spectrometer 300. Even if reflected by the second dichroic mirror 430, the collimating light may still remain collimated. Accordingly, an output condensing optics 450 may be further located between the second dichroic mirror 430 and the spectrometer 300 in order to condense plasma light reflected by the second dichroic mirror 430. The output condensing optics 450 may be, for example, a convex lens. However, a component included in the output condensing optics 450 is not limited to the convex lens. For example, the output condensing optics 450 may further include optical devices configured to condense light.

In the AES 1000b of the present embodiment, the chamber 200a may include the spherical mirror 220a and adopt an input optics corresponding to the spherical mirror 220a, thereby increasing input efficiency of laser beams and output efficiency of plasma light. Thus, the AES 100b of the present embodiment may increase detection intensity to improve analysis reliability. Also, since the AES 1000b of the present embodiment may be fabricated to be downscaled like the AES 1000 of FIG. 1, AESs 1000b may be installed in various positions in a semiconductor manufacturing facility so that a chemical may be analyzed in real-time or periodically during a semiconductor process.

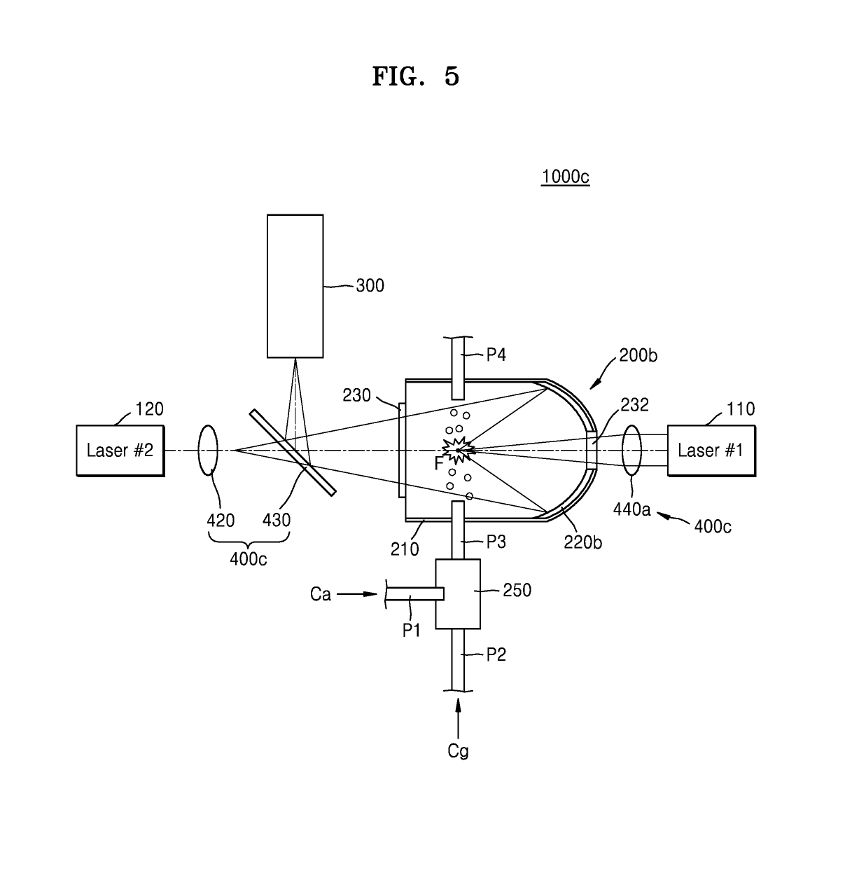

Referring to FIG. 5, an AES 1000c of the present embodiment may differ from the AES 1000 of FIG. 1 in a structure of a chamber 200b and a structure of an input optics 400c. Specifically, in the AES 1000c of the present embodiment, a first laser generator 110 may be located at a right side of the chamber 200b, and pulse laser beams from the first laser generator 110 may be directly irradiated to a focus F of an elliptical mirror 220b of the chamber 200b through an input window 232. The focus F may be located in a central portion of the elliptical mirror 220b.

An additional input optics 440a may be located at a left side of the first laser generator 110 so that the pulse laser beams from the first laser generator 110 may be condensed on the focus F of the elliptical mirror 220b. The additional input optics 440a may include a convex lens. Also, the additional input optics 440a may further include a pair of axicon lenses to generate ring-shaped beams. Meanwhile, the input window 232 may transmit or reflect light according to a wavelength, unlike a window 230 located at a front side of the chamber 200b. For example, the input window 232 may reflect and cut off plasma light and transmit pulse laser beams. Thus, leakage of plasma light may be prevented by the input window 232.

Since the pulse laser beams from the first laser generator 110 are directly incident to the chamber 200b through the additional input optics 440a, the input optics 400c may not include a first dichroic mirror. In other words, the AES 1000 of FIG. 1 may adopt the first dichroic mirror 410 so that pulse laser beams from the first laser generator 110 and CW laser beams from the second laser generator 120 may be incident to the chamber 200 in the same direction. However, the AES 1000c of the present embodiment does not need to adopt the first dichroic mirror because pulse laser beams from the first laser generator 110 are incident to the chamber 200b in an opposite direction to a direction in which CW laser beams from the second laser generator 120 are incident to the chamber 200b. Accordingly, the CW laser beams from the second laser generator 120 may be incident to the chamber 200b through a focal optics 420, a second dichroic mirror 430, and the window 230. Here, the additional input optics 440a may be included in the input optics 400c.

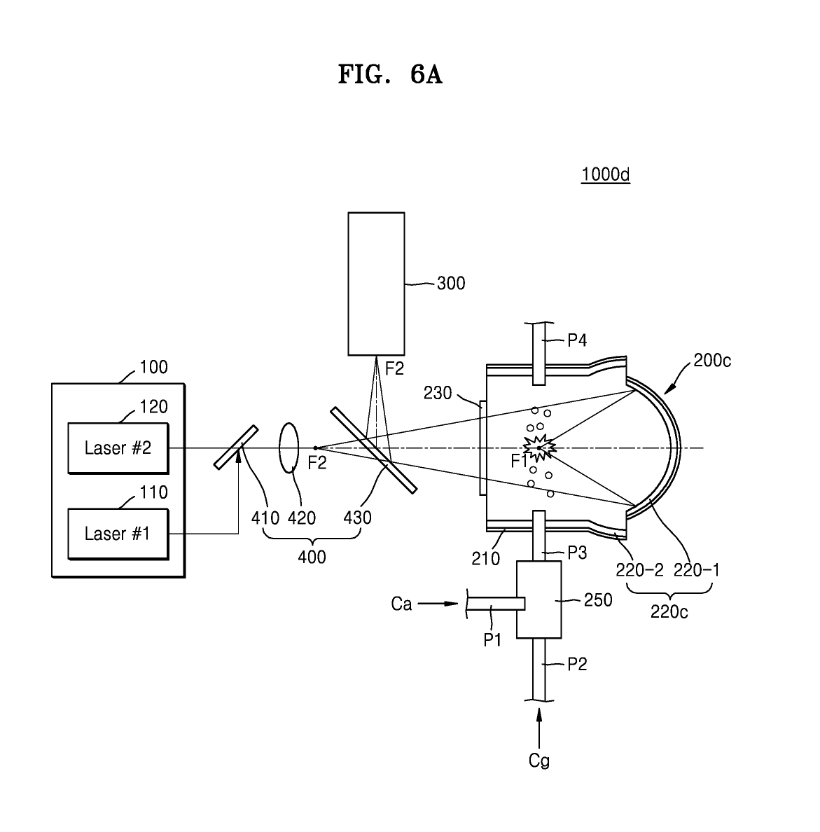

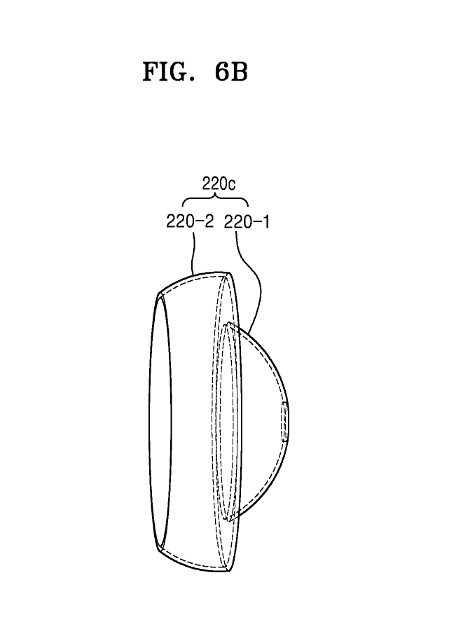

FIG. 6A is a schematic block diagram of a structure of an LIP-based AES according to an exemplary embodiment, and FIG. 6B is a detailed perspective view of a condensing mirror. The same descriptions as in FIGS. 1 to 5 will be simplified or omitted for brevity.

Referring to FIGS. 6A and 6B, an AES 1000d according to the present embodiment may differ from the AES 1000 of FIG. 1 in terms of a structure of a chamber 200c. Specifically, in the AES 1000d according to the present embodiment, the chamber 200c may include a condensing mirror 220c into which an elliptical mirror 220-1 and a spherical mirror 220-2 are merged.

The condensing mirror 220c may serve to reflect plasma light generated at a focus and uniformize an angular intensity distribution of light. The elliptical mirror 220-1 may reflect plasma light and condense the plasma light on a position of a second focus F2 (e.g., an incidence surface of a spectrometer 300). However, when plasma light is condensed by only the elliptical mirror 220-1, the intensity of spatial light at the incidence surface of the spectrometer 300 may have a Gaussian distribution so that an angular intensity distribution of plasma light may be non-uniform. For reference, since optical fibers are typically coupled to the spectrometer 300, the position of the second focus F2 may correspond to an incidence surface of the optical fibers in a strict sense. If a homogenizer is located at a front end of the spectrometer 300, an incidence surface of the homogenizer may correspond to the position of the second focus F2.

In a structure of the elliptical mirror 220-1, light reflected by a central portion of the elliptical mirror 220-1 may have the highest intensity, and light intensity may be continuously reduced toward an outer portion of the elliptical mirror 220-1. Thus, light intensity may be greatly dependent on an incidence angle. Characteristics of the elliptical mirror 220-1 may be determined by a focus of the elliptical mirror 220-1. For example, assuming that a focus in the chamber 200c is a first focus F1 of the elliptical mirror 220-1, a distance from a center of the elliptical mirror 220-1 is a first focal distance L1, a focus outside the chamber 200c is the second focus F2 of the elliptical mirror 220-1, and a distance from the center of the elliptical mirror 220-1 is a second focal distance L2, the amount of plasma light condensed by the elliptical mirror 220-1 may increase as a ratio of L2 to L1 becomes higher. That is, as the ratio of L2 to L1 becomes higher, the first focus F1 may become more adjacent to the elliptical mirror 220-1. Thus, a larger amount of plasma light may be reflected by the elliptical mirror 220-1.

A size of a condensing spot at the second focus F2 on which light reflected by the elliptical mirror 220-1 is condensed may increase by L2/L1 times. Accordingly, as the ratio of L2 to L1 increases, the size of the condensing spot may increase and thus, efficiency of coupling of plasma light with the spectrometer 300 may be reduced. Also, since the intensity of light reflected by the outer portion of the elliptical mirror 220-1 is weak, light intensity may become non-uniform according to an angle. That is, an angular intensity distribution of light may be non-uniform. Here, the angle may refer to an angle (e.g., a solid angle), which may increase away from a center of a concentric circle on a section perpendicular to a direction in which light proceeds.

In contrast, as the ratio of L2 to L1 is reduced, a value of L2/L1 may be reduced so that a small condensing spot may be formed. Thus, efficiency of coupling of plasma light with the spectrometer 300 may increase, and uniformity of an intensity distribution of light relative to an angle may improve. However, when the ratio of L2 to L1 is reduced, the amount of light that may be condensed by the elliptical mirror 220-1 may be reduced as described above. Thus, use efficiency of light may be reduced.

To address the above-described problems of the elliptical mirror 220-1, the AES 1000d according to the present embodiment may adopt the condensing mirror 220c into which the elliptical mirror 220-1 and the spherical mirror 220-2 are combined. A structure of the condensing mirror 220c will now be described in further detail. As shown in FIG. 6A, when the elliptical mirror 220-1 has an open structure on the left, the spherical mirror 220-2 may surround an open portion of the elliptical mirror 220-1 and have an open structure on the left. As shown in FIG. 6B, a diameter of a side of the spherical mirror 220-2 toward the elliptical mirror 220-1 may be greater than a diameter of an open side of the spherical mirror 220-2. Also, the diameter of the side of the spherical mirror 220-2 toward the elliptical mirror 200-1 may be greater than a diameter of the open portion of the elliptical mirror 220-1. Meanwhile, the open side of the spherical mirror 220-2 may have such a diameter as to allow light reflected by the elliptical mirror 200-1 to pass therethrough without blocking. For instance, the diameter of the open side of the spherical mirror 220-2 may be greater than the diameter of the open portion of the elliptical mirror 220-1.

The elliptical mirror 220-1 and the spherical mirror 220-2 may have the same focal position or different focal positions. In the condensing mirror 220c having the above-described structure, light deviating from the elliptical mirror 220-1 may be reflected by the spherical mirror 220-2 and travel toward the elliptical mirror 220-1. The reflected light may be reflected by the elliptical mirror 220-1 again, condensed on the position of the second focus F2, and emitted to increase the amount of reflection of light and use efficiency of light. Also, since light returned by the spherical mirror 220-2 is mostly reflected by the outer portion of the elliptical mirror 220-1, light intensity may increase at the outer portion of the elliptical mirror 220-1. Accordingly, the condensing mirror 220c may uniformize an angular intensity distribution of light.

In the AES 1000d of the present embodiment, the chamber 200c may include the condensing mirror 220c including a combination of the elliptical mirror 220-1 and the spherical mirror 220-2. Thus, most of plasma light emitted from the chamber 200c may be reflected and condensed to increase use efficiency of the plasma light. Also, the intensity of plasma light in the outer portion of the elliptical mirror 220-1 may be increased to uniformize an angular intensity distribution of light.

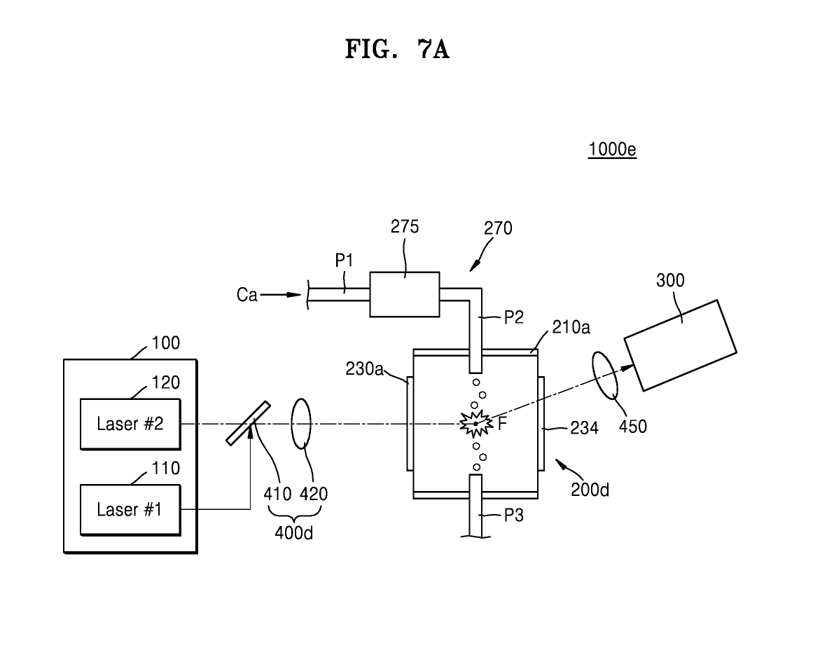

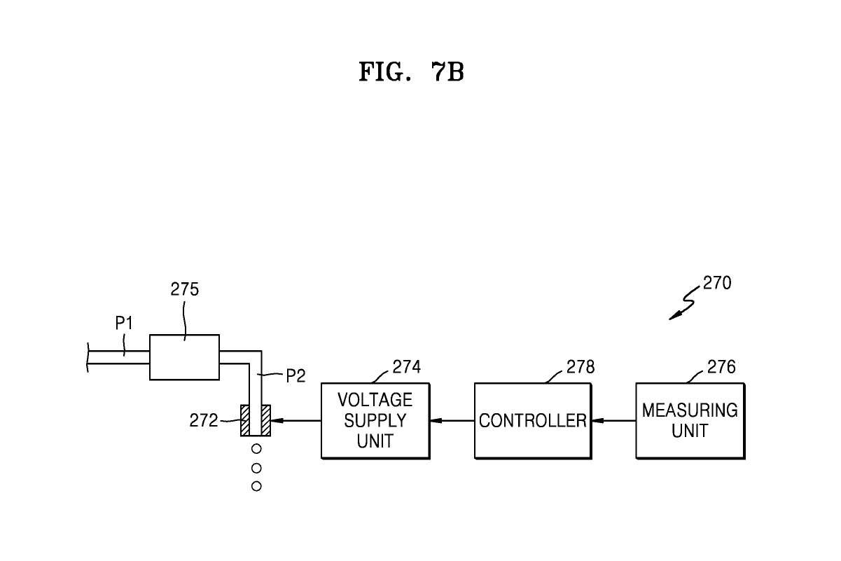

FIG. 7A is a schematic block diagram of a structure of an LIP-based AES according to an exemplary embodiment, and FIG. 7B is a detailed block diagram of a portion of a droplet forming device. The same descriptions as in FIGS. 1 to 2C will be simplified or omitted for brevity.

Referring to FIG. 7A, an AES 1000e of the present embodiment may greatly differ from the AES 1000 of FIG. 1 in that a chamber 200d does not include a mirror configured to condense light and a droplet forming device 270 is used as a device configured to supply an analyte.

Specifically, in the AES 1000e of the present embodiment, a laser generation unit 100 and a spectrometer 300 may be the same as the laser generation unit 100 and the spectrometer 300 included in the AES 1000 of FIG. 1. An input optics 400d may include a first dichroic mirror 410 and a focal optics 420 but not include a second dichroic mirror. Since a condensing mirror is not located in the chamber 200d, the focal optics 420 may allow pulse laser beams from a first laser generator 110 and CW laser beams from a second laser generator 120 to be directly condensed and irradiated to a point at which plasma is to be generated in the chamber 200d. For example, the focal optics 420 may include a convex lens. Also, the focal optics 420 may further include a pair of axicon lenses to convert laser beams into ring-shaped beams.

The chamber 200d may include a body 210a, a first window 230a, and a second window 234. The body 210a may have a hexahedral structure. Naturally, a structure of the body 210a is not limited to the hexahedral structure. For example, the body 210a may have a cylindrical structure. Materials or characteristics of the body 210a may be the same as those of the body 210 of the chamber 200 included in the AES 1000 of FIG. 1.

The first window 230a may be located at a left side surface of the chamber 200d to which laser beams are incident, and serve to transmit or reflect light according to a wavelength. For example, the first window 230a may allow pulse laser beams from the first laser generator 110 and CW laser beams from the second laser generator 120 to be transmitted therethrough and incident to the chamber 200d. Also, the first window 230a may reflect and cut off plasma light generated in the chamber 200d.

The second window 234 may be located at a right side surface from which plasma light is emitted and also, serve to transmit or reflect light according to a wavelength. For example, the second window 234 may reflect and cut off laser beams incident to the chamber 200d, and transmit and emit plasma light generated in the chamber 200d.

An output condensing optics 450 may be located between the second window 234 and the spectrometer 300. The output condensing optics 450 may condense plasma light emitted through the second window 234 toward the spectrometer 300. The output condensing optics 450 may be, for example, a convex lens. However, a component included in the output condensing optics 450 is not limited to the convex lens. For example, the output condensing optics 450 may further include optical devices configured to condense light.

In the AES 1000e of the present embodiment, an analyte Ca, which is in a liquid state, may pass through the droplet forming device 270 and be supplied in a droplet state to the chamber 200d. More specifically, the liquid-state analyte Ca may be supplied through a first supply line P1 into a temporary storage unit 275 of the droplet forming device 270. The analyte Ca may be controlled and put into a droplet state having a predetermined size and supplied through a second supply line P2 into the chamber 200d. Although not shown, a carrier gas, such as argon (Ar), may be supplied through another supply line (not shown) into the chamber 200d. Meanwhile, liquids or gases remaining in the chamber 200 may be discharged through a third supply line P3 located in a lower portion of the chamber 200d. For reference, in the AES 1000 of FIG. 1, since the nebulizer 250 vaporizes an analyte and supplies the vaporized analyte into the chamber 200, the nebulizer 250 may be installed anywhere in the chamber 200. In contrast, in the AES 1000e of the present embodiment, since the droplet forming device 270 supplies an analyte in a liquid state (i.e., a droplet state) into the chamber 200, the droplet forming device 270 may be located in an upper portion of the chamber 200e so that droplets may fall under the influence of gravity.

The droplet forming device 270 may be, for example, embodied by an inkjet device. However, a device embodying the droplet forming device 270 is not limited to the inkjet device. The droplet forming device 270 will be described below in further detail with reference to FIG. 7B.

Referring to FIG. 7B, the droplet forming device 270 may include a first supply line P1, a temporary storage unit 275, and a second supply line P2. The temporary storage unit 275 may be connected to the first supply line P1, receive an analyte through the first supply line P1 and contain the analyte. The analyte stored in the temporary storage unit 275 may be sprayed in a droplet state through a nozzle of an end of the second supply line P2. The temporary storage unit 275 and the second supply line P2 including the nozzle may correspond to a head portion of the droplet forming device 270.

Meanwhile, the droplet forming device 270 may further include an actuator 272 configured to control an ejection amount of droplets, a voltage supply unit 274, a measuring unit 276, and a controller 278. The actuator 272 may be installed at a nozzle of the second supply line P2 and provide driving force for allowing the nozzle to spray droplets. For example, the actuator 272 may allow ink contained in the nozzle to be ejected in a droplet state due to a spray mechanism that contracts and relaxes the nozzle. The spray mechanism due to the actuator 272 may use a piezo method or a thermal method of applying pressure or heat to the nozzle. Therefore, the nozzle may include a material capable of contraction and relaxation due to pressure or heat. However, the spray mechanism due to the actuator 272 or a material included in the nozzle is not limited to the above descriptions.

The voltage supply unit 274 may supply a voltage to the actuator 272 under the control of the controller 278. The actuator 272 installed at the nozzle of the second supply line P2 may be electrically connected to the voltage supply unit 274 and generate spray driving force corresponding to a magnitude of the voltage supplied from the voltage supply unit 274. The measuring unit 276 may measure a velocity, area, and volume of each of droplets and transmit the measured values to the controller 278. The controller 278 may determine whether a drop amount of droplets is appropriate based on measured information, control the magnitude of a voltage applied to the nozzle through the voltage supply unit 274 based on the determination result, and control the drop amount of the droplets sprayed via the nozzle.

The AES 1000e of the present embodiment may supply an analyte in a droplet state through the droplet forming device 270 to the chamber 200d so that the size of droplets may be controlled to enable quantitative analysis of the analyte. Also, the AES 1000e of the present embodiment may irradiate laser beams (e.g., pulse laser beams) to droplets instead of gases so that plasma may be directly generated from the droplets to obtain plasma light having a high intensity. As a result, detection intensity may increase, and analysis reliability may improve.

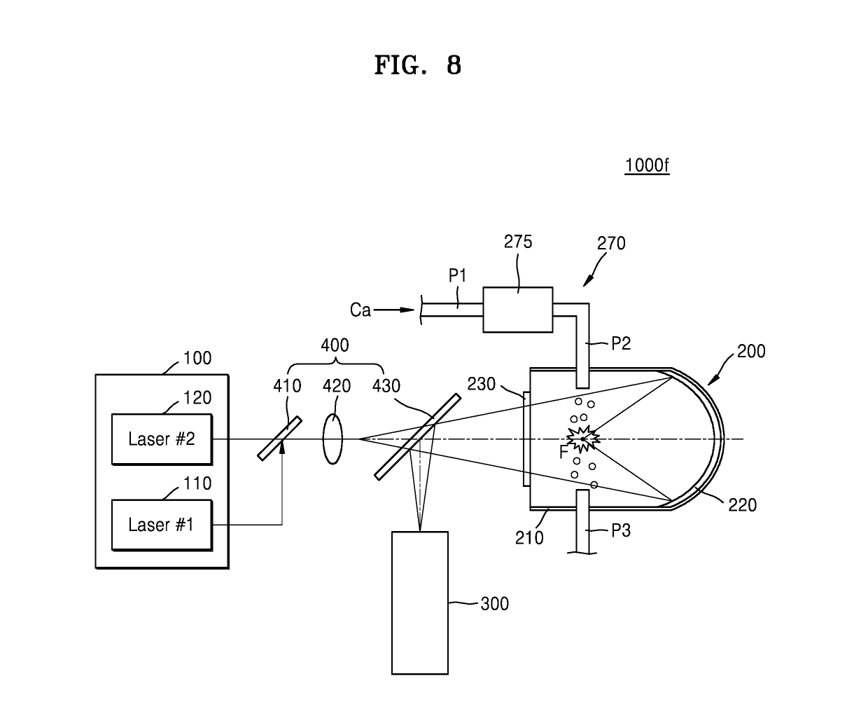

FIG. 8 is a schematic block diagram of a structure of an LIP-based AES according to an embodiment. The same descriptions as in FIGS. 1 to 2C, 7A, and 7B will be simplified or omitted for brevity.

Referring to FIG. 8, an AES 1000f of the present embodiment may be a combination of the AES 1000 of FIG. 1 and the AES 1000e of FIG. 7A. Specifically, in the AES 1000f of the present embodiment, a laser generation unit 100, a chamber 200, a spectrometer 300, and an input optics 400 may be substantially the same as in the AES 1000 of FIG. 1. However, an angle at which a second dichroic mirror 430 is located and a position of the spectrometer 300 may be different than in the AES 1000 of FIG. 1 because a droplet forming device 270 is located over the chamber 200. The droplet forming device 270 may be located in various positions over the chamber 200. Thus, the second dichroic mirror 430 and the spectrometer 300 may be located in substantially the same positions as in the AES 1000 of FIG. 1.

In the AES 1000f of the present embodiment, the droplet forming device 270 may be substantially the same as the AES 1000e of FIG. 7A. Thus, an analyte may be supplied in a droplet state through the droplet forming device 270 into the chamber 200.

In the AES 1000f of the present embodiment, the chamber 200 may adopt an elliptical mirror 220 so as to increase input efficiency of laser beams and output efficiency of plasma light. Also, the chamber 200 may adopt the droplet forming device 270 as a device configured to supply the analyte. Thus, the intensity of plasma light may be increased to further increase detection intensity, and a size of droplets may be quantitatively controlled to perform quantitative analysis on the analyte.

In addition, the nebulizer 250 included in each of the AESs 1000 and 1000a to 1000d of FIGS. 1, 3, 4, 5, and 6A and the droplet forming device 270 included in each of the AESs 1000e and 1000f of FIGS. 7A and 8 have been described above as examples of the device configured to supply the analyte. However, the device configured to supply the analyte is not limited thereto. For example, the device configured to supply the analyte may be simply a pipeline-type supply line including a nozzle.

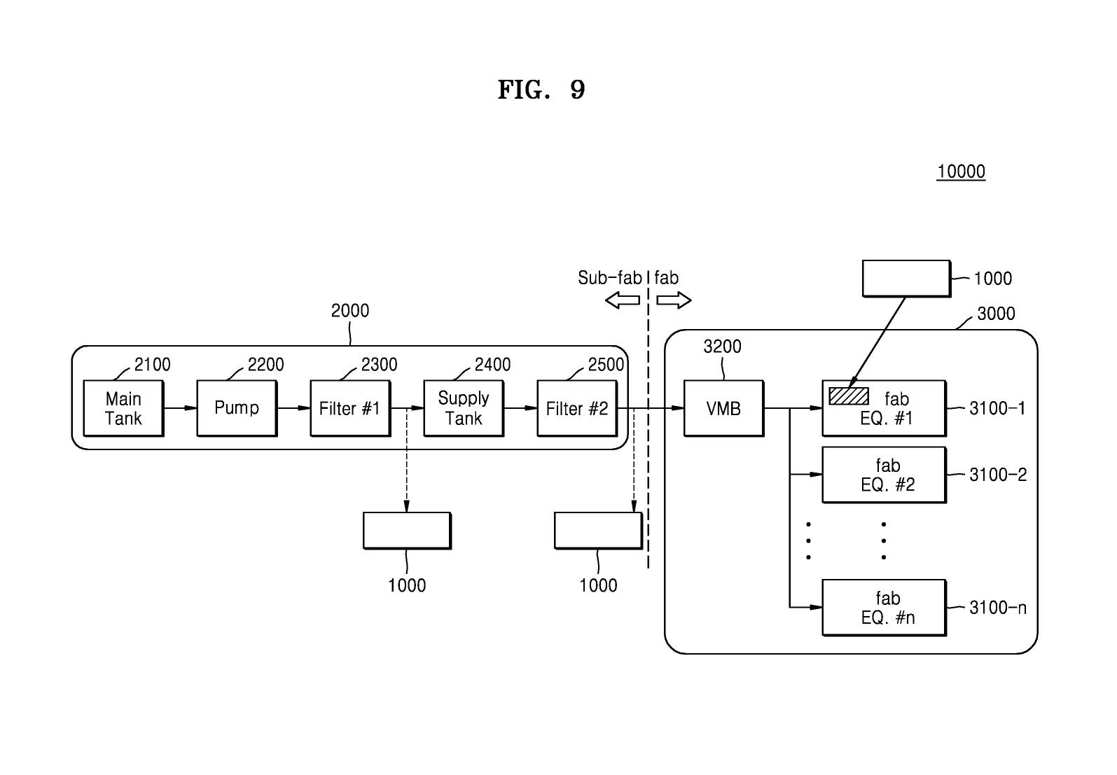

FIG. 9 is a schematic block diagram of a structure of a semiconductor manufacturing facility 10000 including an LIP-based AES according to an exemplary embodiment. The same descriptions as in FIGS. 1 to 8 will be simplified or omitted for brevity.

Referring to FIG. 9, the semiconductor manufacturing facility 10000 according to the present embodiment may include an AES 1000, a central chemical supply system 2000, and a process system 3000. As illustrated with a bold dashed line, the process system 3000 may be typically referred to as a fab facility, and the central chemical supply system 2000 may be referred to as a sub-fab facility.

A semiconductor device may be fabricated by using various semiconductor processes, such as a cleaning process, a lithography process, an etching process, an oxidation process, a diffusion process, a deposition process, and chemical and mechanical polishing processes. In this case, various chemicals may be used in the cleaning, etching, and deposition processes.

The central chemical supply system 2000 may include a main tank 2100, a pump 2200, a first filter 2300, a supply tank 2400, and a second filter 2500. The central chemical supply system 2000 may supply a chemical stored in the main tank 2100 through the pump 2200, the first filter 2300, the supply tank 2400, and the second filter 2500 into the process system 3000 so that the semiconductor process may be performed in the process system 3000.

The process system 3000 may include a plurality of fabrication apparatuses (hereinafter, “fab apparatuses”) 3100-1 to 3100-n and a valve manifold box (VMB) 3200. Each of the fab apparatuses 3100-1 to 3100-n may include apparatuses configured to perform the above-described various semiconductor processes. For example, when the fab apparatuses 3100-1 to 3100-n are apparatuses for a deposition process, each of the fab apparatuses 3100-1 to 3100-n may include a chamber for the deposition process. The VMB 3200 may dividedly supply the chemical from the central chemical supply system 2000 into the respective fab apparatuses 3100-1 to 3100-n.

When there are impurities in a chemical used in a semiconductor process, various process failures may occur. Accordingly, a process of monitoring impurities in the chemical may be needed to reduce the process failures. In general, manufacturers may inspect impurities via a sample test before chemicals are stocked. However, there may be a possibility that impurities may be introduced to deteriorate a chemical during a process of supplying the chemical from the central chemical supply system 2000 to the fab apparatuses 3100-1 to 3100-n.

The semiconductor manufacturing facility 10000 according to the present embodiment may include the AES 1000 installed in the chemical supply line and/or the fab apparatuses 3100-1 to 3100-n to detect impurities during a chemical supply process. For example, the AES 1000 may do sampling and receive a chemical through a T-branch in the chemical supply line and/or the fab apparatuses 3100-1 to 3100-n. For example, the chemical may be supplied through the T-branch to the first supply line (refer to P1 in FIG. 1) and supplied through the nebulizer (refer to 250 in FIG. 1) or the droplet forming device (refer to 270 in FIG. 7A) to the chamber (refer to 200 of FIG. 1 or 200d of 7A). Thus, the semiconductor manufacturing facility 10000 of the present embodiment may, by using the AES 1000, perform an analysis of elements in real-time or periodically during a semiconductor manufacturing process and inspect impurities in the chemical.

As illustrated with dashed arrows in FIG. 9, the AES 1000 may be installed in the chemical supply line. Also, as illustrated with a hatched rectangle and a solid arrow in FIG. 9, the AES 1000 may be installed in the fab apparatuses 3100-1 to 3100-n. Naturally, positions at which the AESs 1000 are installed are not limited to positions denoted in FIG. 9. In the semiconductor manufacturing facility 10000 of the present embodiment, the AES 1000 may be the AES 1000 of FIG. 1. However, the inventive concept is not limited thereto, and the AESs 1000a to 1000f of FIGS. 3 to 8 may be applied to the semiconductor manufacturing facility 10000 of the present embodiment.

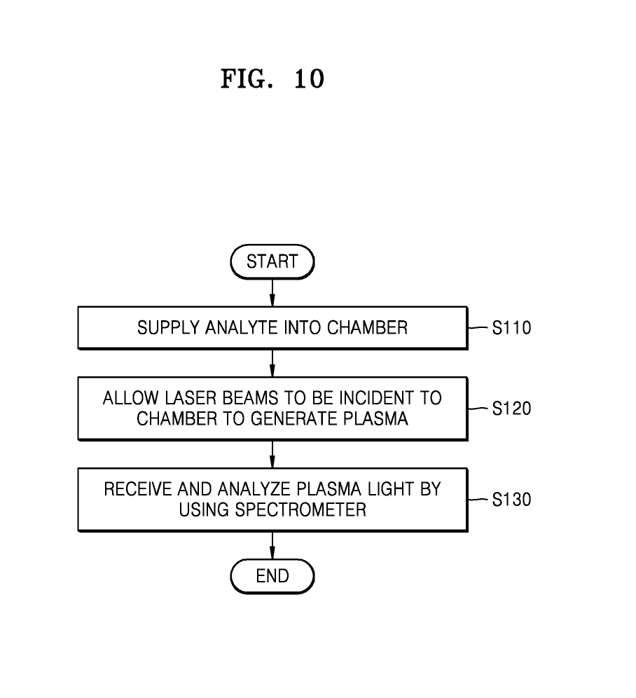

FIG. 10 is a flowchart of a process of analyzing an analyte by using an AES according to an exemplary embodiment. The flowchart of FIG. 10 will be described with reference to FIGS. 1 to 2C for brevity.

Referring to FIG. 10, to begin with, an analyte may be supplied into a chamber 200 (S110). The analyte may be, for example, a chemical used in a semiconductor manufacturing process. The analyte may be supplied in a gaseous state or a droplet state through the nebulizer 250 or the droplet forming device (refer to 270 in FIG. 7A) into the chamber 200.

Laser beams may be incident into the chamber 200 to generate plasma (S120). The laser beams may be, for example, pulse laser beams. Also, the laser beams may further include CW laser beams. The laser beams may be incident through the input optics 400 to the chamber 200. Also, the laser beams may be irradiated through the elliptical mirror 220 included in the chamber 200 and condensed on a position of a focus F of the elliptical mirror 220. Plasma may be generated at the position of the focus F of the elliptical mirror 220.

Meanwhile, plasma light from the plasma may be directly emitted from the chamber 200 and reflected by the elliptical mirror 220, and proceed toward the spectrometer 300 through the second dichroic mirror 430.

Subsequently, plasma light may be received and analyzed by the spectrometer 300 (S130). More specifically, plasma light may be received, split, and resolved by the spectrometer 300 to obtain an emission spectrum. Peaks of intensities of light on the emission spectrum may be examined to detect elements included in the analyte.

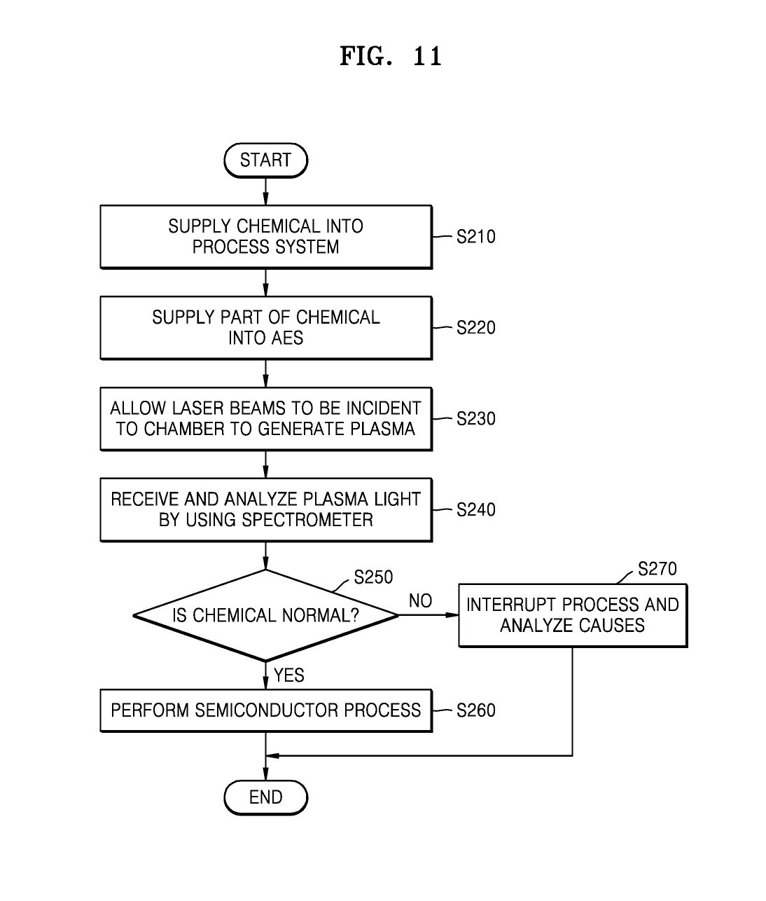

FIG. 11 is a flowchart of a process of manufacturing a semiconductor device by using an AES 1000 according to an exemplary embodiment. For brevity, the flowchart of FIG. 11 will be described with reference to FIGS. 1 to 2C and 9, and the same descriptions as in FIG. 10 will be simplified or omitted.

Referring to FIG. 11, to begin with, a chemical for a semiconductor manufacturing process may be supplied into a process system 3000 (S210). For example, the chemical may be supplied from a central chemical supply system 2000 into fab apparatuses 3100-1 to 3100-n of the process system 3000.

Part of the chemical may be supplied into the AES 1000 (S220). Part of the chemical may be supplied through a T-branch in a chemical supply line and/or the fab apparatuses 3100-1 to 3100-n into the AES 1000. For example, the chemical may be supplied through the T-branch to a first supply line P1 and supplied in a gaseous state through a nebulizer 250 into the chamber 200. For reference, the present operation S220 may correspond to operation S120 of supplying an analyte in the analysis process of FIG. 10.

Subsequently, operation S230 of generating plasma and operation S240 of analyzing plasma light may be performed. The operations S230 and S240 may be respectively the same as the operation S120 of generating plasma and the operation S130 of analyzing plasma light in the analysis process of FIG. 10.

It may be determined whether the chemical is normal based on the analysis result (S250). For example, it may be determined whether impurity elements are included in the chemical. Also, in some embodiments, quantitative analysis may be performed to determine whether the impurity elements exceed a reference concentration.

If the chemical is not normal (No), the semiconductor manufacturing process may be interrupted, and causes may be analyzed. Also, repair and maintenance operations may be performed on the chemical supply line of the central chemical supply system 2000 and/or the fab apparatuses 3100-1 to 3100-n based on the analysis of the causes.

If the chemical is normal (Yes), a semiconductor process may be performed (S260). Here, the semiconductor process may be a concept including a semiconductor process using the above-described chemical and a semiconductor process subsequent thereto. The semiconductor process may include, for example, a deposition process, an etching process, an ion process, and a cleaning process. The semiconductor process may be performed to form integrated circuits (ICs) and interconnections respectively required for semiconductor chips of a wafer. Specifically, the semiconductor process may include a step of supplying a chemical gas into a deposition chamber so that a gate insulating film is formed at a semiconductor device, and also, a step of supplying another chemical gas into an oxidation chamber to form an oxide film over a layer of a semiconductor element. Meanwhile, a process of analyzing a chemical may be performed again in the subsequent semiconductor process.

In the present operation S260, the semiconductor process may also include a process of singulating the wafer into respective semiconductor chips, a process of packaging the semiconductor chips, and a process of testing the semiconductor chips or a semiconductor package. Accordingly, operation S260 may include a concept including a process of manufacturing semiconductor devices as finished products.

While the inventive concept has been particularly shown and described with reference to exemplary embodiments thereof, it will be understood that various changes in form and details may be made therein without departing from the spirit and scope of the following claims.

What is claimed is:

1. An atomic emission spectrometer (AES) comprising:
at least one laser generator configured to generate laser beams;
a chamber comprising an elliptical or spherical mirror disposed inside the chamber and configured to reflect the laser beams transmitted into the chamber so that the laser beams are condensed and irradiated on an analyte contained in the chamber to generate plasma and emit plasma light;
a supplier connected to the chamber to supply the analyte into the chamber; and
a spectrometer configured to receive and analyze the plasma light, and obtain data regarding the plasma light to detect elements in the analyte.

2. The AES of claim 1, wherein the supplier comprises a first supply line through which the analyte is supplied into the chamber, and a second supply line through which a gas in the chamber is discharged.

3. The AES of claim 1, wherein the supplier is further configured to supply a carrier gas into the chamber.

4. The AES of claim 1, wherein the supplier is connected to the chamber to supply the analyte while the plasma is generated.

5. The AES of claim 1, wherein the supplier comprises a nebulizer configured to vaporize a liquid-state analyte to generate the analyte to be supplied into the chamber.

6. The AES of claim 1, wherein the supplier comprises a droplet forming device configured to supply the analyte in a liquid state to into the chamber.

7. The AES of claim 1, wherein the chamber comprises a window through which the laser beams are transmitted into the chamber, and the plasma light is emitted out to the spectrometer,
wherein the mirror comprises an elliptical mirror disposed on a portion of an inner surface of the chamber which faces the window,
wherein the elliptical mirror is configured to have two foci by which light from any one of the two foci is reflected by the elliptical mirror and travels toward the other one of the two foci, whereby the laser beams are reflected by the elliptical mirror and condensed on a condensing point to generate the plasma, and the plasma light is emitted out to the spectrometer though the window.

8. The AES of claim 1, further comprising an optics comprising a first dichroic mirror through which the laser beams generated at the laser generator are transmitted into the chamber, and the plasma light is emitted out to the spectrometer.

9. The AES of claim 8, wherein the laser generator comprises:
a first laser generator configured to generate first laser beams to ignite the plasma in the chamber; and
a second laser generator configured to generate second laser beams to maintain an inside of the chamber at a high temperature, and
wherein the optics further comprises a second dichroic mirror through which the first laser beams and the second laser beams are combined to the laser beams and transmitted into the chamber.

10. The AES of claim 9, wherein the mirror disposed inside the chamber comprises an elliptical mirror configured to reflect the laser beams transmitted into the chamber to a first focus of the elliptical mirror where the laser beams are condensed and irradiated on the analyte to generate the plasma, and
wherein the optics further comprises at least one lens disposed between the first and second dichroic mirrors to generate a second focus of the elliptical mirror between the lens and the first dichroic mirror.

11. The AES of claim 9, wherein the mirror disposed inside the chamber comprises an elliptical mirror configured to reflect the laser beams transmitted into the chamber to a first focus of the elliptical mirror where the laser beams are condensed and irradiated on the analyte to generate the plasma, and
wherein the optics further comprises at least one lens disposed between the second laser generator and the second dichroic mirror to generate a second focus of the elliptical mirror between the lens and the second dichroic mirror.

12. The AES of claim 11, wherein the optics further comprises a first optics disposed between the first laser generator and the second dichroic mirror, and configured to convert the first laser beams into a ring-shaped beams.

13. The AES of claim 12, wherein the first optics comprises a concave lens configured to expand the ring-shaped beams.

14. The AES of claim 1, wherein the chamber comprises a window through which the laser beams are transmitted into the chamber, and
wherein the mirror comprises a spherical mirror disposed on a portion of an inner surface of the chamber which faces the window, and configured to reflect the laser beams so that the laser beam are condensed on a condensing point to generate the plasma, and the plasma light is emitted out though the window.

15. The AES of claim 14, further comprising an optics comprising a collimating optics and a first dichroic mirror,
wherein the collimating optics is configured to convert the laser beams into ring-shaped beams, which are transmitted through the first dichroic mirror into the chamber, and
wherein the plasma light is emitted through the first dichroic mirror into the spectrometer.

16. The AES of claim 1, wherein the laser beams comprise the first laser beams and the second laser beams,
wherein the laser generator comprises a first laser generator configured to generate first laser beams to ignite the plasma in the chamber, and a second laser generator configured to generate second laser beams to maintain an insider of the chamber at a high temperature,
wherein the mirror comprises an elliptical mirror disposed on a portion of an inner surface of the chamber, and configured to reflect the second laser beams transmitted into the chamber to a condensing point where the first laser beams are condensed and irradiated on the analyte to generate the plasma, and
wherein the chamber comprises a first window through which the first laser beams are transmitted into the chamber, and a second window through which the second laser beams are transmitted into the chamber and the plasma light is emitted out to the spectrometer.

17. The AES of claim 1, wherein the chamber comprises a window through which the laser beams are transmitted into the chamber, and the plasma light is emitted out to the spectrometer,
wherein the mirror comprises an elliptical mirror and a spherical mirror connected to each other such that a part of the laser beams deviating from the elliptical mirror is reflected by the spherical mirror to travel toward the elliptical mirror and be reflected by the elliptical mirror to be condensed on a condensing point to generate the plasma.

18. The AES of claim 1, wherein the spectrometer comprises at least one of a homogenizer configured to spatially uniformize the plasma light input to the spectrometer, and a condensing optics configured to condense the plasma light input to the spectrometer.

19. An atomic emission spectrometer (AES) comprising:
a chamber configured to receive an analyte;
at least one laser generator configured to generate laser beams;
an optics comprising a focal optics through which the laser beams are transmitted onto a condensing point formed inside the chamber to generate plasma;
a supplier connected to the chamber to supply the analyte into the chamber; and
a spectrometer configured to receive and analyze plasma light from the plasma, and obtain data regarding the plasma light to detect elements in the analyte.

20. The AES of claim 19, wherein the chamber comprises a first window through which the laser beams are transmitted into the chamber, and a second window through which the plasma light is emitted out to the spectrometer.

21. The AES of claim 20, wherein the supplier comprises a droplet forming device configured to supply the analyte in a liquid state to into the chamber.

22. A semiconductor manufacturing system comprising:
a chemical storage configured to store a chemical used for at least one of processes comprising cleaning, lithography, etching, oxidation, diffusion and deposition, and polishing;
at least one chamber configured to receive the chemical which is applied to a semiconductor for performing the at least one process;
a chemical supplier configured to supply the chemical into the at least one chamber for the at least one process; and
the atomic emission spectrometer (AES) of claim 1 configured to receive the chemical comprising the analyte and analyse the analyte.

23. The semiconductor manufacturing system of claim 22, wherein the chamber comprises a window through which the laser beams are transmitted into the chamber, and the plasma light is emitted out to the spectrometer,
wherein the mirror comprises an elliptical mirror disposed on a portion of an inner surface of the chamber which faces the window,
wherein the elliptical mirror is configured to have two foci by which light from any one of the two foci is reflected by the elliptical mirror and travels toward the other one of the two foci, whereby the laser beams are reflected by the elliptical mirror and condensed on a condensing point to generate the plasma, and the plasma light is emitted out to the spectrometer though the window.

24. The semiconductor manufacturing system of claim 22, wherein the AES further comprises an optics comprising a first dichroic mirror through which the laser beams generated at the laser generator are transmitted into the chamber, and the plasma light is emitted out to the spectrometer.

25. A method of manufacturing a semiconductor element, the method comprising:
storing a chemical used for at least one of processes comprising cleaning, lithography, etching, oxidation, diffusion, deposition, and polishing;
supplying analyte comprising a part of the chemical into an atomic emission spectrometer (AES) for analyzing the analyte; and
supplying the chemical into at least one chamber for performing the at least one process according to a result of the analyzing the analyte,
wherein the analyzing the analyte by the AES comprises:
supplying the analyte into a chamber of the AES;
applying laser beams into the chamber so that the laser beams are reflected by a mirror disposed in the chamber to be condensed and irradiated on the analyte to generate plasma and emit plasma light therefrom; and
controlling the plasma light to emit out to a spectrometer which analyzes the plasma light.

26. The method of claim 25, wherein the chemical comprises a gas to form a film which insulates a gate of a semiconductor element,
wherein the supplying the chemical into at least one chamber for performing the at least one process comprises supplying the gas into a deposition chamber to deposit the gas to form a gate insulating film.

27. The method of claim 26, wherein the chemical comprises a gas to form an oxide film over a layer of a semiconductor element,
wherein the supplying the chemical into at least one chamber for performing the at least one process comprises supplying the gas into an oxidation chamber to oxide the layer of the semiconductor element.

28. The method of claim 25, wherein the analyte is supplied into the chamber while the plasma is generated.

29. The method of claim 28, wherein the applying the laser beams into the chamber comprises:
transmitting first laser beams to maintain an inside of the chamber at a high temperature; and
transmitting second laser beams to ignite the plasma in the chamber.

30. The method of claim 29, wherein the transmitting the second laser beams is continued while the plasma is maintained in the chamber from a moment when the plasma is ignited.
